(19) United States
(12) Patent Application Publication
(10) Pub. No.: US 2019/0018738 A1
(43) Pub. Date: Jan. 17, 2019

(54) METHOD FOR PERFORMING REPLICATION CONTROL IN A STORAGE SYSTEM WITH AID OF CHARACTERISTIC INFORMATION OF SNAPSHOT, AND ASSOCIATED APPARATUS

(71) Applicant: Synology Incorporated, Taipei (TW)

(72) Inventor: Hui-Wen Chen, Taipei (TW)

(21) Appl. No.: 15/646,107

(22) Filed: Jul. 11, 2017

(51) Int. Cl. G06F 11/14

(52) U.S. Cl. CPC G06F 11/1451; G06F 2201/84; G06F 11/1464

(57) ABSTRACT

A method for performing replication control in a storage system and an associated apparatus are provided. The method may include: generating a snapshot of a protection target in the source storage server and characteristic information of the snapshot, and storing the snapshot together with the characteristic information in the source storage server; transmitting replication data of the snapshot from the source storage server to the destination storage server, to generate a replication version of the snapshot in the destination storage server, the replication version including the characteristic information; and searching for at least one common snapshot between the source storage server and the destination storage server at least according to both of the characteristic information of the snapshot and the characteristic information within the replication version, and utilizing a latest common snapshot within the at least one common snapshot as reference of replication difference calculation for further replication.

### BACKGROUND OF THE INVENTION

### 1. Field of the Invention

The present invention relates to storage management, and more particularly, to a method for performing replication control in a storage system, and an associated apparatus.

### 2. Description of the Related Art

For a storage system that is capable of performing replication on snapshots, when there is something wrong with a system configuration file, some problems may occur. For example, when the system configuration file is damaged or missing, or becomes invalid due to disk migration of the storage system, certain linking relationship(s) between the snapshots may become unknown to the storage system. As a result, the storage system may automatically perform unnecessary data transmission for replication, and the high bandwidth usage in a network may degrade the overall performance of the storage system. Thus, a novel method and associated architecture are required for enhancing the overall performance of the storage system.

### SUMMARY OF THE INVENTION

One of the objects of the present invention is to provide a method for performing replication control in a storage system, and an associated apparatus, to solve the problems which exist in the related arts.

Another of the objects of the present invention is to provide a method for performing replication control in a storage system, and an associated apparatus, to guarantee the overall performance of the storage system.

According to at least one embodiment of the present invention, a method for performing replication control in a storage system is provided. The storage system may include a source storage server and a destination storage server. The method may include: generating a snapshot of a protection target in the source storage server and characteristic information of the snapshot, and storing the snapshot together with the characteristic information of the snapshot in the source storage server, in which the snapshot is one of a plurality of snapshots of the protection target that are stored in the source storage server; transmitting replication data of the snapshot from the source storage server to the destination storage server, to generate a replication version of the snapshot in the destination storage server, in which the replication version of the snapshot includes the characteristic information of the snapshot; and searching for at least one common snapshot between the source storage server and the destination storage server at least according to both of the characteristic information of the snapshot in the source storage server and the characteristic information within the replication version in the destination storage server, and utilizing a latest common snapshot within the at least one common snapshot as reference of replication difference calculation for further replication within the storage system, in which the snapshot is determined as the latest common snapshot.

According to at least one embodiment of the present invention, an apparatus for performing replication control in a storage system is provided. The storage system may include a source storage server and a destination storage server. The apparatus may include a processing circuit that is positioned in the source storage server. The processing circuit may be arranged to control operations of the source storage server, and controlling the operations of the source storage server may include: generating a snapshot of a protection target in the source storage server and characteristic information of the snapshot, and storing the snapshot together with the characteristic information of the snapshot in the source storage server, in which the snapshot is one of a plurality of snapshots of the protection target that are stored in the source storage server; transmitting replication data of the snapshot from the source storage server to the destination storage server, to generate a replication version of the snapshot in the destination storage server, in which the replication version of the snapshot includes the characteristic information of the snapshot; and searching for at least one common snapshot between the source storage server and the destination storage server at least according to both of the characteristic information of the snapshot in the source storage server and the characteristic information within the replication version in the destination storage server, and utilizing a latest common snapshot within the at least one common snapshot as reference of replication difference calculation for further replication within the storage system, in which the snapshot is determined as the latest common snapshot.

The method and associated apparatus of the present invention may solve problems existing in the related arts without introducing unwanted side effects, or in a way that is less likely to introduce a side effect. In addition, the method and associated apparatus of the present invention can properly select a snapshot as reference of replication difference calculation according to characteristic information of snapshot(s), to reduce bandwidth consumption. Additionally, the method and associated apparatus of the present invention can guarantee the overall performance of the storage system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a storage system according to an embodiment of the present invention.

FIG. 2 illustrates some replication operations of the storage system shown in FIG. 1 according to an embodiment of the present invention.

FIG. 3 is a flowchart of a method for performing replication control in a storage system according to an embodiment of the present invention.

FIG. 4 illustrates a control scheme of the method shown in FIG. 3 according to an embodiment of the present invention.

FIG. 5 illustrates some program modules related to the method shown in FIG. 3 according to an embodiment of the present invention.

FIG. 6 illustrates a working flow of the method shown in FIG. 3 according to an embodiment of the present invention.

FIG. 7 illustrates the latest common snapshot of some common snapshots that is found through the method shown in FIG. 3 according to an embodiment of the present invention.

FIG. 8 illustrates the latest common snapshot of some common snapshots that is found through the method shown in FIG. 3 according to another embodiment of the present invention.

FIG. 9 illustrates a working flow of the method shown in FIG. 3 according to an embodiment of the present invention.

FIG. 10 illustrates one or more broken relationships that can be relinked through the method shown in FIG. 3 according to an embodiment of the present invention.

FIG. 11 illustrates one or more broken relationships that can be relinked through the method shown in FIG. 3 according to another embodiment of the present invention.

FIG. 12 illustrates one or more broken relationships that can be relinked through the method shown in FIG. 3 according to yet another embodiment of the present invention.

### DETAILED DESCRIPTION

Embodiments of the present invention provide a method for performing replication control in a storage system, and provide an associated apparatus. The storage system may include a source storage server (e.g. a server utilized as a source of replication) and a destination storage server (e.g. a server utilized as a destination of replication). Based on the method, the apparatus may control the storage system to properly replicate at least one snapshot (e.g. one or more snapshots) from the source storage server to the destination storage server without introducing the related art problems.

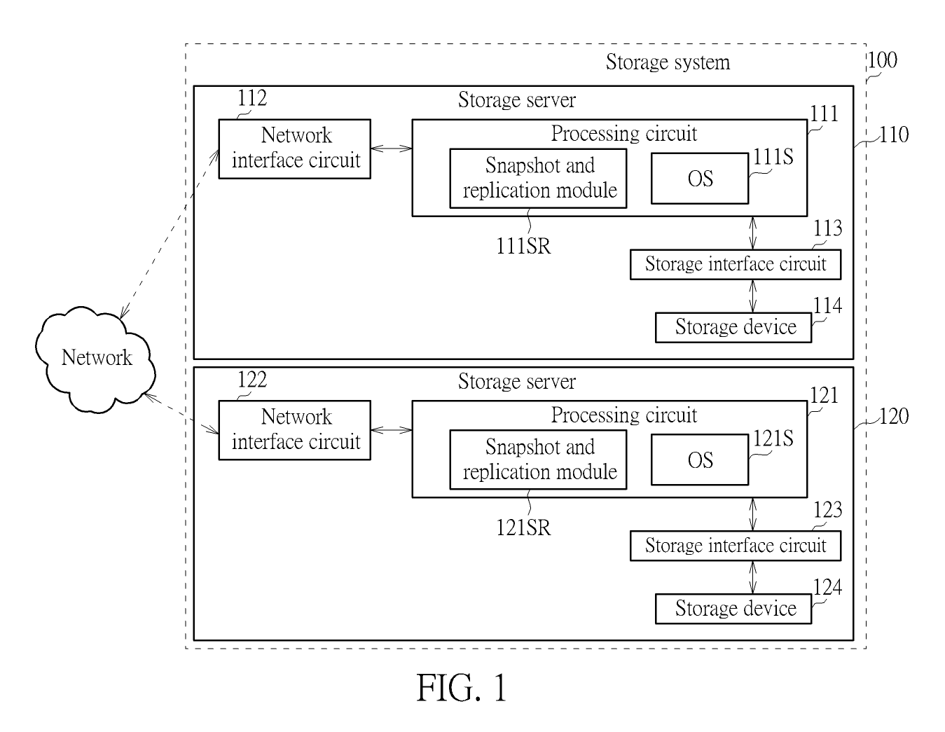

FIG. 1 is a diagram of a storage system 100 according to an embodiment of the present invention. The storage system 100 may be taken as an example of the aforementioned storage system. As shown in FIG. 1, the storage system 100 may include storage servers 110 and 120, which may be taken as examples of the source storage server and the destination storage server, respectively. The storage server 110 may include a processing circuit 111 (e.g. at least one processor, and associated circuits such as a chipset, a random access memory (RAM), etc.), a network interface circuit 112, a storage interface circuit 113, and at least one storage device (e.g. one or more storage devices, such as hard disk drives (HDDs) and/or solid state drives (SSDs)) which may be collectively referred to as the storage device 114. One or more program modules may run on the processing circuit 111 (more particularly, the processor thereof) to control operations of the storage server 110, for example, according to the method. The one or more program modules running on the processing circuit 111 may include a snapshot and replication module 111SR and an operating system (OS) 111S. In addition, the storage server 120 may include a processing circuit 121 (e.g. at least one processor, and associated circuits such as a chipset, a RAM, etc.), a network interface circuit 122, a storage interface circuit 123, and at least one storage device (e.g. one or more storage devices, such as HDDs and/or SSDs) which may be collectively referred to as the storage device 124. One or more program modules may run on the processing circuit 121 (more particularly, the processor thereof) to control operations of the storage server 120, for example, according to the method. The one or more program modules running on the processing circuit 121 may include a snapshot and replication module 121SR and an OS 121S. Additionally, a user of the storage system 100 may access the storage system 100 through a client device (not shown), and the client device may include a processing circuit (e.g. at least one processor, and associated circuits such as a chipset, a RAM, etc.) and a network interface circuit. The client device and the storage servers 110 and 120 may be coupled to each other through at least one network, in which wired and/or wireless network connections may be utilized.

According to this embodiment, both of the storage servers 110 and 120 may be implemented as network attached storage (NAS) devices, and the client device may be any of a multifunctional mobile phone, a laptop computer, a tablet, etc. For example, the user may access at least one active storage server within the storage system 100 (e.g. one or both of the storage servers 110 and 120) after logging in to the active storage server through a browser running on the processing circuit of the client device (more particularly, the processor thereof). In addition, the apparatus may include at least one portion (e.g. a portion or all) of the aforementioned storage system such as the storage system 100. For example, the apparatus may include a portion of the storage server 110, and more particularly, may include the processing circuit 111. In another example, the apparatus may include the whole of the storage server 110. In another example, the apparatus may include the whole of the storage system 100.

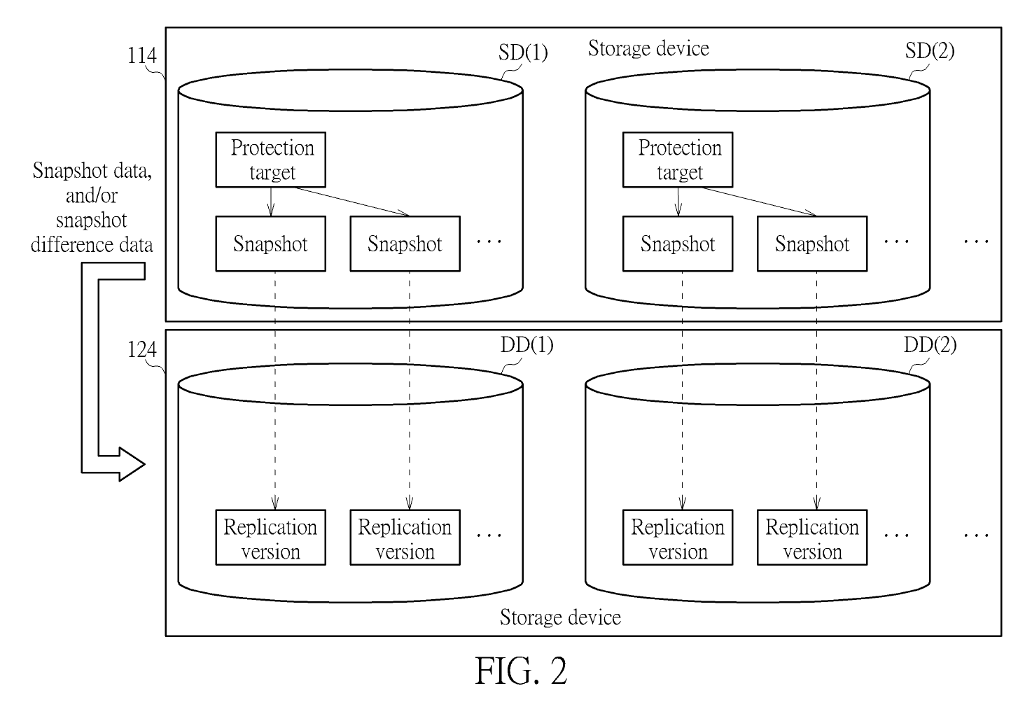

FIG. 2 illustrates some replication operations of the storage system 100 shown in FIG. 1 according to an embodiment of the present invention. The storage devices SD(1), SD(2), etc. (e.g. HDDs and/or SSDs) may be taken as examples of the aforementioned at least one storage device within the storage device 114 shown in FIG. 1, and the storage devices DD(1), DD(2), etc. (e.g. HDDs and/or SSDs) may be taken as examples of the aforementioned at least one storage device within the storage device 124 shown in FIG. 1. Under control of the processing circuit 111, the storage server 110 may allow the user to assign some objects in the file system of the storage server 110 as protection targets, respectively. Examples of any of the objects may include, but are not limited to: a folder, a directory, a file, etc. The processing circuit 111 may control the storage server 110 to generate snapshots of a specific protection target (e.g. any of the protection targets) with respect to time, and allow the user to restore to any snapshot within the snapshots (e.g. a snapshot corresponding to a specific time point). In addition, the processing circuit 111 may control the storage server 110 to trigger replication operations related to the snapshots of the specific protection target, to replicate the snapshots to the storage server 120. As a result, the storage server 110 may transmit snapshot data and/or snapshot difference data to the storage server 120, and the processing circuit 121 may generate replication versions of the snapshots in the storage server 120. As a copy of the object which has been assigned as the specific protection target by the user may exist in the storage server 120, and as there are the replication versions of the snapshots in the storage server 120, the storage server 120 may be utilized as a replacement or backup device of the storage server 110 when needed. For example, in a situation where the storage server 110 malfunctions or is damaged, the user may access the storage server 120, rather than the storage server 110. In this situation, the replication versions in the storage server 120 may be regarded as snapshots of the aforementioned copy of the object (i.e. the copy in the storage server 120), so the copy of the object may be protected by the replication versions in the storage server 120. For better comprehension, some examples of the protection targets and the associated snapshots are illustrated in the upper half of FIG. 2, and some examples of the associated replication versions are illustrated in the lower half of FIG. 2.

According to some embodiments, the snapshots may be generated in at least one Btrfs region of the storage device 114 (e.g. Btrfs regions in the storage devices SD(1), SD(2), etc., respectively), and the replication versions may be generated in at least one Btrfs region of the storage device 124 (e.g. Btrfs regions in the DD(1), DD(2), etc., respectively), but the present invention is not limited thereto.

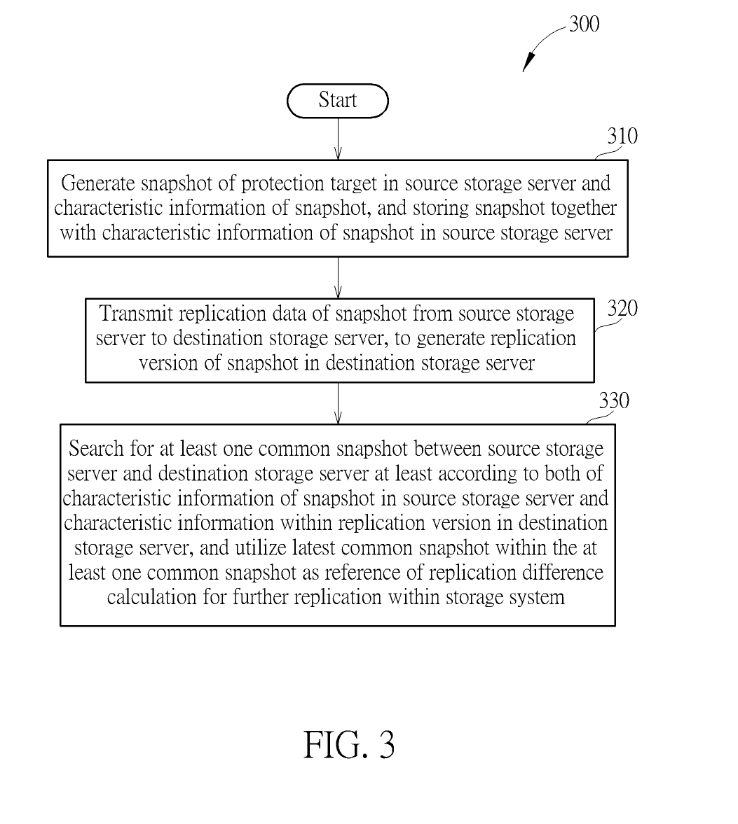

FIG. 3 is a flowchart of a method 300 for performing replication control in a storage system according to an embodiment of the present invention. The method 300 may be taken as an example of the method mentioned above. The method 300 may be applied to the storage system 100, and may be applied to the storage server 110 and the processing circuit 111 therein. For better comprehension, in Step 310 through to Step 330, the source storage server and the destination storage server may be described as the storage servers 110 and 120, respectively.

In Step 310, the processing circuit 111 may generate a snapshot of a protection target (e.g. the specific protection target mentioned above) in the storage server 110 and characteristic information of the snapshot, and store the snapshot together with the characteristic information of the snapshot in the storage server 110. For example, the snapshot mentioned in Step 310 may be one of a plurality of snapshots of the protection target that are stored in the storage server 110.

In Step 320, the processing circuit 111 may transmit replication data of the snapshot from the storage server 110 to the storage server 120, to generate a replication version of the snapshot in the storage server 120. In this step, the replication version of the snapshot may include the characteristic information of the snapshot.

In Step 330, the processing circuit 111 may search for at least one common snapshot (e.g. one or more common snapshots) between the storage server 110 and the storage server 120 at least according to both of the characteristic information of the snapshot in the storage server 110 and the characteristic information within the replication version in the storage server 120, and utilize the latest common snapshot within the aforementioned at least one common snapshot as reference of replication difference calculation for further replication within the storage system 100. For example, the snapshot mentioned in Step 310 may be determined as the latest common snapshot.

According to this embodiment, the characteristic information of the snapshot mentioned in Step 310 is different from that of any other one of the plurality of snapshots. For example, the characteristic information of the snapshot may include, but are not limited to: a unique identifier (UID) of the snapshot. More particularly, as the implementation of the UID may vary, the UID may include one or a combination of a serial number, a random number, a code, and a text string, but the present invention is not limited thereto. In addition, the characteristic information (e.g. the UID) of the snapshot and that (e.g. another UID) of the aforementioned any other one of the plurality of snapshots may be utilized for indicating the order of generating the plurality of snapshots in the storage server 110. For example, the processing circuit 111 may perform the same operation as that of Step 310 on each of the plurality of snapshots. As a result, the processing circuit 111 can perform replication control with aid of the respective characteristic information of at least one portion (e.g. a portion or all) of the plurality of snapshots. Please note that the operation of Step 330 can be performed, no matter whether the aforementioned any other one of the plurality of snapshots is within the aforementioned at least one common snapshot of Step 330 or not.

For better comprehension, suppose that a previous snapshot of the protection target may be generated before the snapshot mentioned in Step 310 is generated, and the previous snapshot is within the plurality of snapshots, in which the previous snapshot may be taken as an example of the aforementioned any other one of the plurality of snapshots. The processing circuit 111 may generate the previous snapshot of the protection target and characteristic information (e.g. a different UID which is different from the UID, such as the other UID, for example) of the previous snapshot, and may store the previous snapshot together with the characteristic information of the previous snapshot in the storage server 110. The characteristic information (e.g. the different UID) of the previous snapshot and the characteristic information (e.g. the UID) of the snapshot mentioned in Step 310 may indicate that the time of generating the previous snapshot is prior to the time of generating the snapshot. In addition, the processing circuit 111 may determine the order of generating the plurality of snapshots in the storage server 110 at least according to both of the characteristic information (e.g. the different UID) of the previous snapshot and the characteristic information (e.g. the UID) of the snapshot mentioned in Step 310. For example, the aforementioned at least one common snapshot of Step 330 may include multiple common snapshots between the storage servers 110 and 120, and the common snapshots may include the snapshot mentioned in Step 310 and the previous snapshot. The processing circuit 111 may select the snapshot mentioned in Step 310 as the latest common snapshot according to the order that is determined at least according to both of the characteristic information (e.g. the different UID) of the previous snapshot and the characteristic information (e.g. the UID) of the snapshot mentioned in Step 310. Please note that the operation of Step 330 can be performed, no matter whether the previous snapshot is within the aforementioned at least one common snapshot of Step 330 or not.

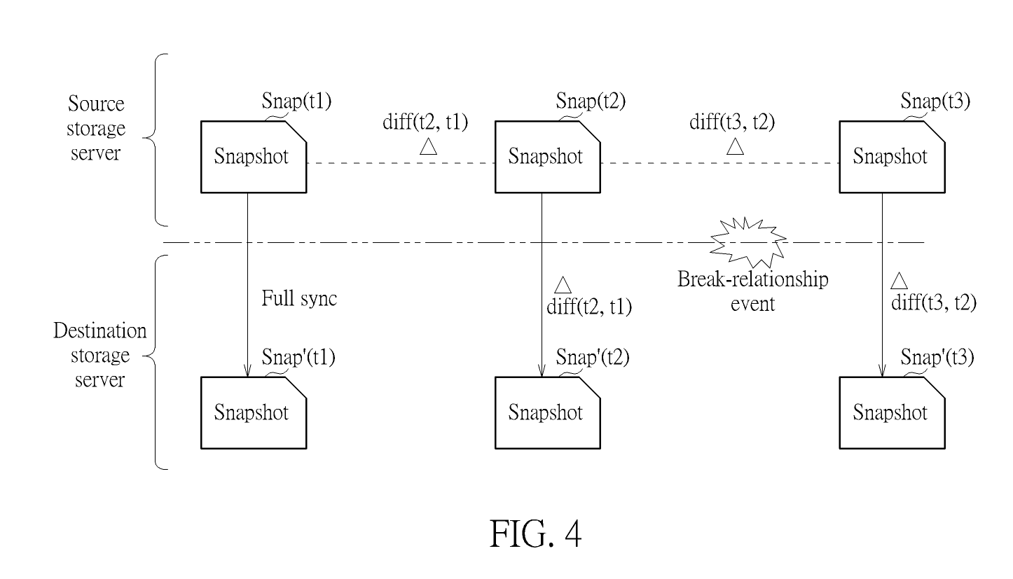

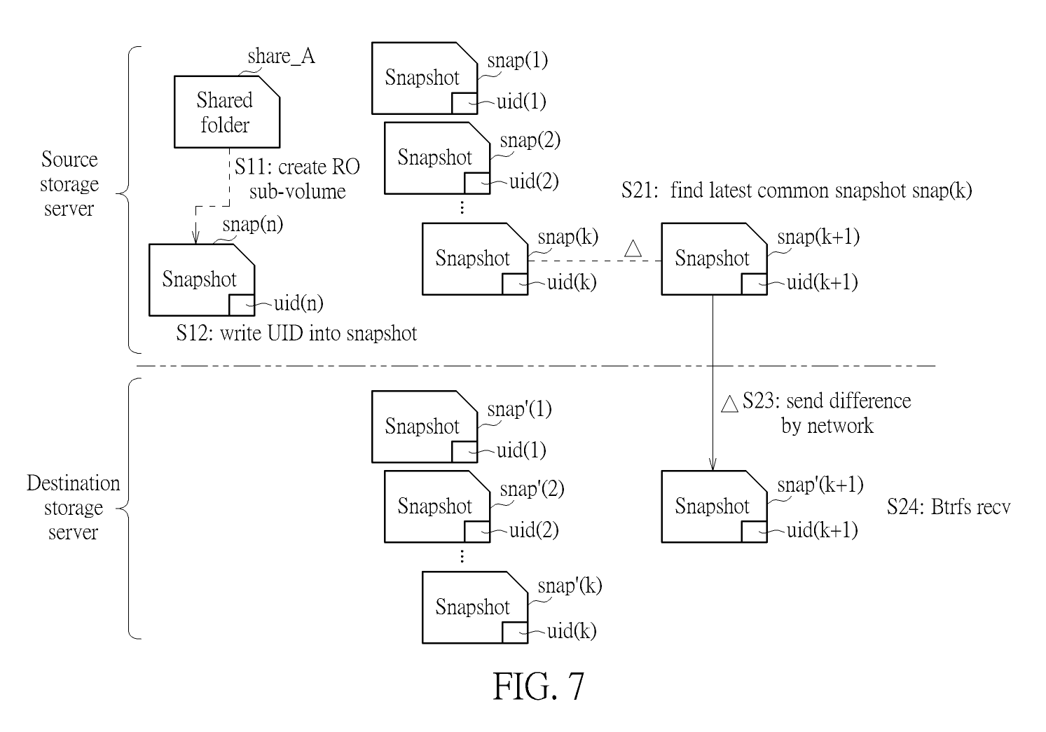

According to some embodiments (e.g. any of the embodiments respectively shown in FIG. 4 and FIG. 7), the aforementioned at least one common snapshot of Step 330 may include multiple common snapshots between the storage servers 110 and 120, and the snapshot mentioned in Step 310 may be one of the common snapshots. The processing circuit 111 may select the snapshot mentioned in Step 310 as the latest common snapshot according to the characteristic information (e.g. the UID) of the snapshot mentioned in Step 310 and that (e.g. a different UID which is different from the UID, such as the other UID, for example) of any other one of the common snapshots.

FIG. 4 illustrates a control scheme of the method 300 shown in FIG. 3 according to an embodiment of the present invention. As shown in FIG. 4, there are some snapshots (e.g. the snapshots Snap(t1), Snap(t2), and Snap(t3)) and corresponding replication versions (e.g. the snapshots Snap′(t1), Snap′(t2), and Snap′(t3)) in the storage system 100. For example, the protection target may be a folder (e.g. a shared folder), and may originally include multiple files {F1, F2, . . . , F101} therein before the time point t1. The snapshots Snap(t1), Snap(t2), and Snap(t3) may be generated at the time points t1, t2, and t3, respectively. As the protection target originally includes the files {F1, F2, . . . , F101} before the time point t1, the snapshot Snap(t1) may also include the files {F1, F2, . . . , F101}. The storage system 100 may perform a full synchronization operation (labeled “Full sync” in FIG. 4, for brevity) to transmit all of the file content data of the files {F1, F2, . . . , F101} from the storage server 110 to the storage server 120. In addition, at an intermediate time point in the time interval [t1, t2], the user may add a file F102 in the protection target, so the snapshot Snap(t2) may include the files {F1, F2, . . . , F102}. Regarding replicating the snapshot Snap(t2) from the storage server 110 to the storage server 120, the processing circuit 111 may determine that the snapshot Snap(t1) appears in both of the storage servers 110 and 120 since the snapshots Snap′(t1) is the corresponding replication version of the snapshots Snap(t1). Based on this determination, the processing circuit 111 may calculate the difference diff(t2, t1) between the snapshot Snap(t2) and the snapshot Snap(t1), such as the file content data of the file F102, and transmit the difference diff(t2, t1) from the storage server 110 to the storage server 120. Additionally, at an intermediate time point in the time interval [t2, t3], the user may add a file F103 in the protection target, so the snapshot Snap(t3) may include the files {F1, F2, . . . , F103}. Afterward, a break-relationship event (e.g. an event that breaks the linking relationship(s) between some snapshots) may occur in the time interval [t2, t3]. Examples of the break-relationship event may include, but are not limited to: a system configuration crashing event, and a disk migration event.

According to this embodiment, searching for the aforementioned at least one common snapshot of Step 330 is performed after replication relationship information indicating at least one replication relationship related to at least one of the snapshot mentioned in Step 310 and the replication version of the snapshot (e.g. the replication version mentioned in Step 320) is missing. More particularly, the replication relationship information may be stored in a system configuration file in a file system of at least one (e.g. one or more) of the storage server 110 and the storage server 120, and searching for the aforementioned at least one common snapshot of Step 330 is performed after the system configuration file is damaged or missing or becomes invalid. For example, in the system configuration crashing event which may be taken as an example of the break-relationship event, the system configuration file may be damaged or missing. As a result, the replication relationship information is missing. For another example, in the disk migration event which may be taken as another example of the break-relationship event, the system configuration file may become invalid due to disk migration (e.g. disk migration of the storage system 100). As a result, the replication relationship information is missing. No matter what happens in the break-relationship event, the present invention method (e.g. the method 300) and the associated apparatus (e.g. the storage system 100, the storage server 110, the processing circuit 111, etc.) can relink the linking relationship(s) such as the aforementioned at least one replication relationship to prevent unnecessary data transmission for replication, such as a full synchronization operation of transmitting all of the file content data of the files {F1, F2, . . . , F103} from the storage server 110 to the storage server 120.

Regarding replicating the snapshot Snap(t3) from the storage server 110 to the storage server 120, the processing circuit 111 may perform the operation of searching for the aforementioned at least one common snapshot of Step 330 according to the common characteristic information of the snapshots Snap(t1) and Snap′(t1) (e.g. a first UID embedded in each of the snapshots Snap(t1) and Snap′(t1)) and according to the common characteristic information of the snapshots Snap(t2) and Snap′(t2) (e.g. a second UID embedded in each of the snapshots Snap(t2) and Snap′(t2), in which the second UID is different from the first UID and indicates that the snapshot Snap(t2) is generated after the snapshot Snap(t1) is generated) to determine that the series of snapshots Snap(t1) and Snap(t2) appears in each of the storage servers 110 and 120 and that the snapshot Snap(t2) is the latest common snapshot within the series of snapshots Snap(t1) and Snap(t2). Based on this determination, the processing circuit 111 may calculate the difference diff(t3, t2) between the snapshot Snap(t3) and the snapshot Snap(t2), such as the file content data of the file F103, and transmit the difference diff(t3, t2) from the storage server 110 to the storage server 120, rather than performing any full synchronization operation (e.g. transmitting all of the file content data of the files {F1, F2, . . . , F103} from the storage server 110 to the storage server 120). For better comprehension, the difference diff(t2, t1) may be taken as an example of the snapshot difference data and the difference diff(t3, t2) may be taken as another example of the snapshot difference data, but the present invention is not limited thereto.

According to some embodiments, the replication relationship information may be a portion of system information of the file system of the aforementioned at least one of the storage server 110 and the storage server 120. According to some embodiments, the aforementioned at least one replication relationship may include one or more of various types of replication relationships between snapshot(s) in the storage server 110 and/or snapshot(s) in the storage server 120. For example, the aforementioned at least one replication relationship may include a relationship between the snapshot mentioned in Step 310 and another snapshot within the plurality of snapshots. In addition, the replication relationship information may be a portion of system information of the file system of the storage server 110. For another example, the aforementioned at least one replication relationship may include a relationship between the snapshot and the replication version of the snapshot. In addition, the replication relationship information may be a portion of system information of the file system of at least one of the storage server 110 and the storage server 120 (e.g. one or a combination of the system information of the file system of the storage server 110 and/or the system information of the file system of the storage server 120). For yet another example, the replication version of the snapshot (e.g. the replication version mentioned in Step 320) may be one of a plurality of replication versions in the storage server 120, and the aforementioned at least one replication relationship may include a relationship between the replication version of the snapshot and another replication version within the plurality of replication versions. In addition, the replication relationship information may be a portion of system information of the file system of the storage server 120. No matter what happens in an event such as the break-relationship event, the present invention method (e.g. the method 300) and the associated apparatus (e.g. the storage system 100, the storage server 110, the processing circuit 111, etc.) can relink the aforementioned at least one replication relationship to prevent unnecessary data transmission for replication.

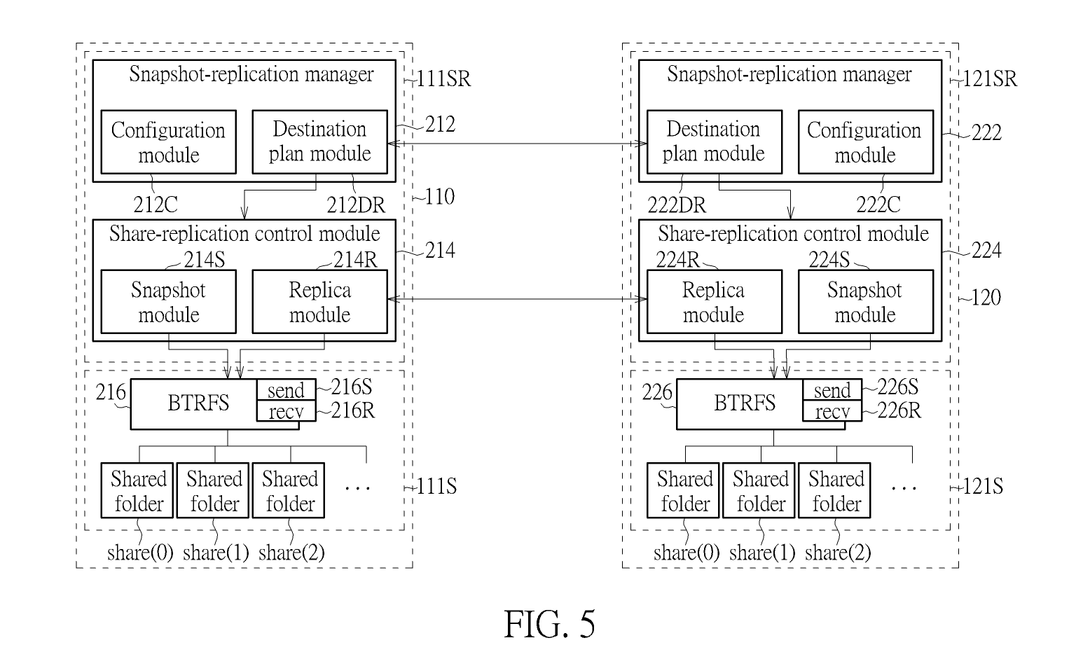

According to some embodiments (e.g. any of the embodiments respectively shown in FIGS. 5-8), regarding the operation of storing the snapshot together with the characteristic information of the snapshot in the storage server 110 in Step 310, the processing circuit 111 may integrate the characteristic information (e.g. the UID) of the snapshot into the snapshot to store the characteristic information of the snapshot as a portion of the snapshot, to make the replication version of the snapshot in the storage server 120 be searchable in a searching operation regarding the aforementioned at least one common snapshot of Step 330. For example, the operation of searching for the aforementioned at least one common snapshot of Step 330 may be performed in the searching operation. More particularly, in Step 320, the replication data transmitted from the storage server 110 to the storage server 120 may include the characteristic information (e.g. the UID) of the snapshot.

FIG. 5 illustrates some program modules related to the method 300 shown in FIG. 3 according to an embodiment of the present invention. The snapshot and replication module 111SR may include a snapshot-replication manager 212 and a share-replication control module 214, in which the snapshot-replication manager 212 may include a configuration module 212C and a destination plan module 212DR and the share-replication control module 214 may include a snapshot module 214S and a replica module 214R. In addition, the OS 111S may include a file system such as a BTRFS (or Btrfs) 216 including some program sub-modules such as send 216S and recv 216R, and the BTRFS 216 may control some basic operations of multiple protection targets such as the shared folders {share(0), share(1), share(2), . . . }. The BTRFS 216 and the send 216S and the recv 216R thereof are known in the related art, so their implementation details are omitted here. Similarly, the snapshot and replication module 121SR may include a snapshot-replication manager 222 and a share-replication control module 224, in which the snapshot-replication manager 222 may include a configuration module 222C and a destination plan module 222DR and the share-replication control module 224 may include a snapshot module 224S and a replica module 224R. In addition, the OS 121S may include a file system such as a BTRFS (or Btrfs) 226 including some program sub-modules such as send 2265 and recv 226R, and the BTRFS 226 may control some basic operations of multiple protection targets such as the shared folders {share′(0), share′(1), share′(2), . . . }. The BTRFS 226 and the send 2265 and the recv 226R thereof are known in the related art, so their implementation details are omitted here. For better comprehension, each of the snapshot-replication managers 212 and 222 may be regarded as an upper layer, each of the share-replication control modules 214 and 224 may be regarded as an intermediate layer, and each of the BTRFSs 216 and 226 may be regarded as a lower layer.

The snapshot-replication managers 212 and 222 may manage replication operations of snapshots according to the method 300 and control the working flows correspondingly, and the configuration modules 212C and 222C may store the associated replication configurations and the destination plan modules 212DR and 222DR may store the associated replication plans. In addition, the share-replication control modules 214 and 224 may perform replication control of the shared folders {share(0), share(1), share(2), . . . } and {share′(0), share′(1), share′(2), . . . } through the BTRFSs 216 and 226, respectively, in which the snapshot modules 214S and 224S may control operations regarding generating snapshots and the replica modules 214R and 224R may control operations regarding snapshot replication (e.g. replication data transmission). As a result, all snapshots in the storage servers 110 and 120 may have their own characteristic information embedded therein (e.g. UIDs), respectively. No matter what happens in the break-relationship event, the present invention method (e.g. the method 300) and the associated apparatus (e.g. the storage system 100, the storage server 110, the processing circuit 111, etc.) can relink the linking relationship(s) such as the aforementioned at least one replication relationship according to the characteristic information embedded in at least one portion (e.g. a portion or all) of these snapshots in the storage servers 110 and 120 to prevent unnecessary data transmission for replication. For brevity, similar descriptions for this embodiment are not repeated in detail here.

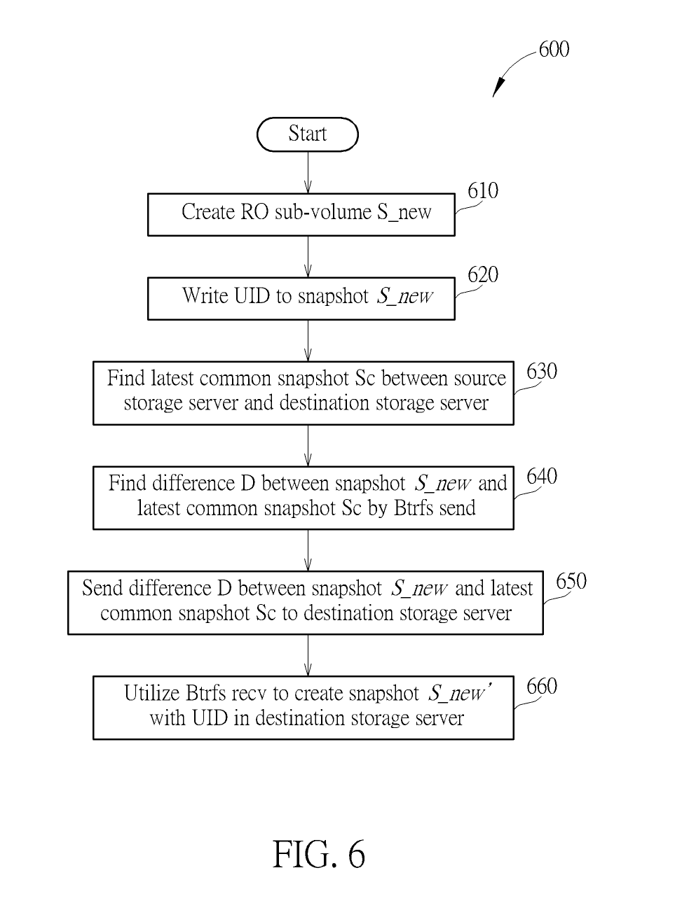

FIG. 6 illustrates a working flow 600 of the method 300 shown in FIG. 3 according to an embodiment of the present invention. The working flow 600 may be arranged to synchronize replication.

In Step 610, the processing circuit 111 (e.g. the BTRFS 216, under control of the snapshot-replication manager 212 and/or the share-replication control module 214) may create a Read-Only (RO) sub-volume S_new such as a snapshot S_new in the source storage server (e.g. the storage server 110).

In Step 620, the processing circuit 111 (e.g. the BTRFS 216, under control of the snapshot-replication manager 212 and/or the share-replication control module 214) may write a UID such as that mentioned above to the snapshot S_new.

In Step 630, the processing circuit 111 (e.g. the BTRFS 216, under control of the snapshot-replication manager 212 and/or the share-replication control module 214) may find the latest common snapshot Sc between the source storage server (e.g. the storage server 110) and the destination storage server (e.g. the storage server 120), such as the latest common snapshot mentioned in Step 330.

In Step 640, the processing circuit 111 (e.g. the BTRFS 216, under control of the snapshot-replication manager 212 and/or the share-replication control module 214) may find the difference D between the snapshot S_new and the latest common snapshot Sc by Btrfs send (e.g. the send 216S of the BTRFS 216). The difference D may be taken as an example of the snapshot difference data, but the present invention is not limited thereto.

In Step 650, the processing circuit 111 (e.g. the snapshot-replication manager 212 and/or the share-replication control module 214) may send the difference D between the snapshot S_new and the latest common snapshot Sc to the destination storage server (e.g. the storage server 120).

In Step 660, the processing circuit 121 may utilize Btrfs recv (e.g. the recv 226R of the BTRFS 226) to create a snapshot S_new′ with the UID mentioned in Step 620 in the destination storage server (e.g. the storage server 120).

FIG. 7 illustrates the latest common snapshot of some common snapshots that is found through the method 300 shown in FIG. 3 according to an embodiment of the present invention. The shared folder share_A may represent one of the shared folders {share(0), share(1), share(2), . . . }. According to this embodiment, the processing circuit 111 (e.g. the BTRFS 216, under control of the snapshot-replication manager 212 and/or the share-replication control module 214) may create a RO sub-volume (in Step S11) such as any snapshot Snap(n) within the plurality of snapshots mentioned in Step 310, where the index n may be a positive integer. In addition, the processing circuit 111 may write a UID uid(n) into the snapshot Snap(n) (in Step S12). As a result of performing similar operations as above, the processing circuit 111 may generate a series of snapshots snap(1), snap(2), snap(k), and snap(k+1) having the UIDs uid(1), uid(2), . . . , uid(k), and uid(k+1) embedded therein, respectively. Additionally, as the storage system 100 may perform replication from the storage server 110 to the storage server 120, the processing circuit 121 may generate corresponding replication versions of the snapshots {snap(1), snap(2), . . . , snap(k)} in the storage server 120, such as the snapshots {snap′(1), snap′(2), . . . , snap′(k)}, in which the snapshots {snap′(1), snap′(2), . . . , snap′(k)} have the UIDs {uid(1), uid(2), . . . , uid(k)} embedded therein, respectively.

Regarding replicating the snapshot snap(k+1) from the storage server 110 to the storage server 120, the processing circuit 111 may find the latest common snapshot snap(k) within the series of snapshots snap(1), snap(2), . . . , snap(k), and snap(k+1) (in Step S21). Based on this, the processing circuit 111 may perform Btrfs send (e.g. the send 216S of the BTRFS 216) to find the difference (which may be illustrated with a triangle, for better comprehension) between the snapshot snap(k+1) and the latest common snapshot snap(k) (in Step S22). In addition, the processing circuit 111 may send the difference by the network (in Step S23). As a result, the processing circuit 121 may perform Btrfs recv (e.g. the recv 226R of the BTRFS 226) to generate the snapshot snap′(k+1) (in Step S24). For brevity, similar descriptions for this embodiment are not repeated in detail here.

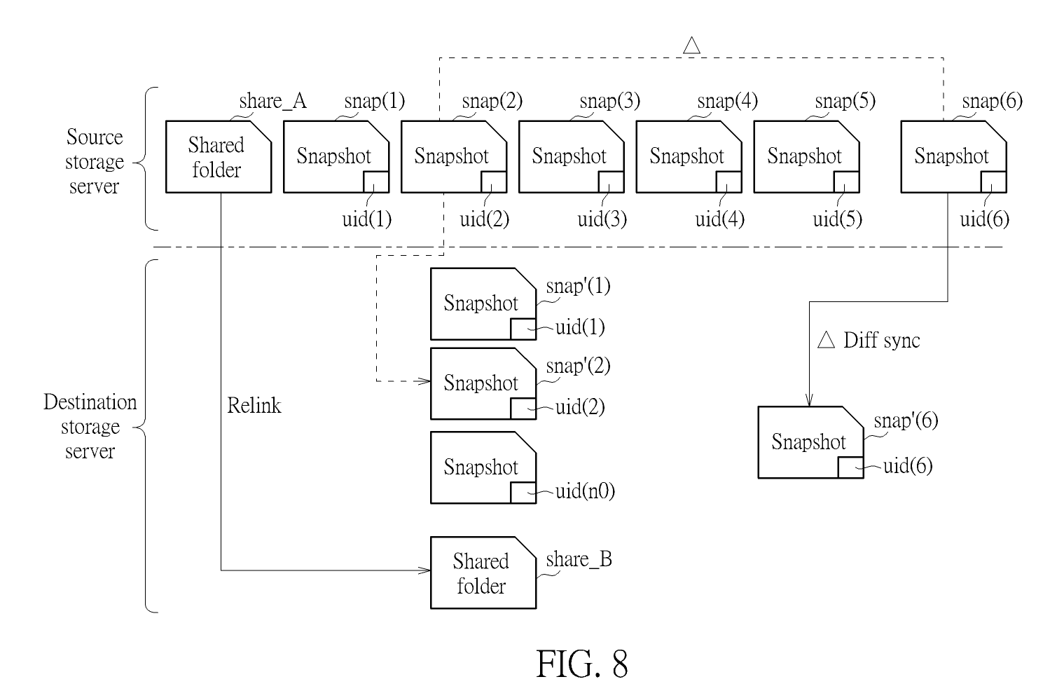

FIG. 8 illustrates the latest common snapshot of some common snapshots that is found through the method 300 shown in FIG. 3 according to another embodiment of the present invention. The shared folder share_A may represent any shared folder within the shared folders {share(0), share(1), share(2), . . . } (e.g. the shared folder share(0)), and the shared folder share_B may represent a corresponding shared folder within the shared folders {share′(0), share′(1), share′(2), . . . } (e.g. the shared folder share′(0)). For example, when k=5, the series of snapshots snap(1), snap(2), . . . , snap(k), and snap(k+1) may include the snapshots snap(1), snap(2), snap(3), snap(4), snap(5), and snap(6) having the UIDs uid(1), uid(2), uid(3), uid(4), uid(5), and uid(6) embedded therein, respectively. Although the break-relationship event may occur, the present invention method (e.g. the method 300) and the associated apparatus (e.g. the storage system 100, the storage server 110, the processing circuit 111, etc.) can relink the linking relationship(s) such as the replication relationships between the snapshots of the shared folders share_A and share_B to prevent unnecessary data transmission for replication, such as a full synchronization operation of transmitting all of the file content data of the files in the shared folder share_A from the storage server 110 to the storage server 120. For better comprehension, an arrow from the shared folder share_A of the storage server 110 to the corresponding shared folder share_B of the storage server 120 may be illustrated to indicate that the apparatus relinks the replication relationships between the snapshots of the shared folders share_A and share_B.

Regarding replicating the snapshot snap(6) from the storage server 110 to the storage server 120, the processing circuit 111 may find and select the common snapshot(s) (e.g. the snapshots {snap(1), snap(2)}) from the series of snapshots snap(1), snap(2), snap(3), snap(4), snap(5), and snap(6) according to the UID (s) in the common snapshot(s). For example, the UID uid(1) in the snapshot snap(1) that also appears the snapshots snap′(1) may indicate that the snapshot snap(1) is one of the common snapshot(s), and the UID uid(2) in the snapshot snap(2) that also appears the snapshot snap′(2) may indicate that the snapshot snap(2) is one of the common snapshot(s). The UID uid(n0) in a snapshot stored in the storage server 120 does not appear in any snapshot stored in the storage server 110, so the snapshot having the UID uid(n0) should not be one of the common snapshot(s) and may be regarded as an irrelevant snapshot. For example, the snapshot having the UID uid(n0) may be generated by the storage server 120 due to a certain reason (e.g. a previous configuration of the storage system 100). In addition, the processing circuit 111 may find and select the latest common snapshot(e.g. the snapshot snap(2)) from the common snapshot(s) according to the UID(s) in the common snapshot(s). For example, the UIDs {uid(1), uid(2)} of the snapshots {snap(1), snap(2)} may indicate the order of generating the snapshots {snap(1), snap(2)}}, and more particularly, may indicate that the snapshot snap(2) is generated after the snapshot snap(1) is generated, so the processing circuit 111 may determine that the snapshot snap(2) is the latest common snapshot. Thus, the processing circuit 111 may utilize the latest common snapshot such as the snapshot snap(2) as the reference of replication difference calculation for further replication of the snapshot snap(6). Based on this, the processing circuit 111 may find the difference (which may be illustrated with a triangle, for better comprehension) between the snapshot snap(6) and the latest common snapshot snap(2). Additionally, the processing circuit 111 may send the difference, in which the operation of sending the difference may be regarded as difference synchronization (labeled “Diff sync” in FIG. 8, for brevity). As a result, the processing circuit 121 may generate the snapshot snap′(6). For brevity, similar descriptions for this embodiment are not repeated in detail here.

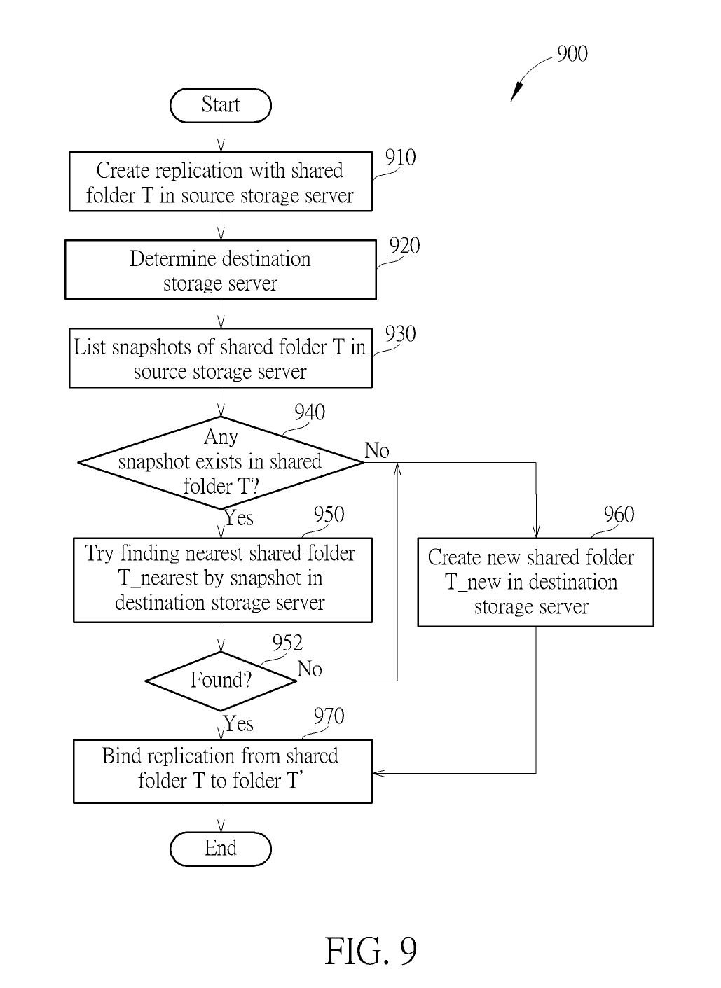

FIG. 9 illustrates a working flow 900 of the method 300 shown in FIG. 3 according to an embodiment of the present invention. The working flow 900 may be arranged to relink replication relationships.

In Step 910, the processing circuit 111 (e.g. the BTRFS 216, under control of the snapshot-replication manager 212 and/or the share-replication control module 214) may create replication with a shared folder T in the source storage server such as the storage server 110.

In Step 920, the processing circuit 111 (e.g. the snapshot-replication manager 212 and/or the share-replication control module 214) may determine the destination storage server such as the storage server 120.

In Step 930, the processing circuit 111 (e.g. the BTRFS 216, under control of the snapshot-replication manager 212 and/or the share-replication control module 214) may list snapshots of the shared folder T in the source storage server such as the storage server 110.

In Step 940, based on a listing result of the listing operation of Step 930, the processing circuit 111 may check whether any snapshot exists in the shared folder T or not. If yes (e.g. the snapshot(s) exist), Step 950 is entered; otherwise, Step 960 is entered.

In Step 950, the processing circuit 111 may try finding a nearest shared folder T_nearest (which is not in the destination storage server) by snapshot(s) in the destination storage server such as the storage server 120.

In Step 952, the processing circuit 111 may check whether the nearest shared folder T_nearest is found or not. When the nearest shared folder T_nearest is found, Step 970 is entered, with the nearest shared folder T_nearest being utilized as the folder T′ mentioned in Step 970; otherwise, Step 960 is entered.

In Step 960, the processing circuit 111 may create a new shared folder T_new in the destination storage server such as the storage server 120. Afterward, Step 970 is entered, with the new shared folder T_new being utilized as the folder T′ mentioned in Step 970.

In Step 970, the processing circuit 111 may bind replication from the shared folder T to the folder T′(e.g. the nearest shared folder T_nearest or the new shared folder T_new).

According to some embodiments, a certain HDD may be recently added into the storage server 110 by the user to perform disk migration, and the nearest shared folder T_nearest may be found in the recently added HDD, but the present invention is not limited thereto. According to some embodiments, when any snapshot stored in a folder of the recently added HDD has any UID that also appears in a snapshot in the shared folder T, the processing circuit 111 may determine this folder as the nearest shared folder T_nearest, but the present invention is not limited thereto.

According to some embodiments, the method 300 can be applied to the architecture of any of various types of topologies, in which the storage system 100 may include two or more storage servers such as sites A, B, and/or C having the corresponding shared folders (e.g. shared folders share_A, share_B, and/or share_C).

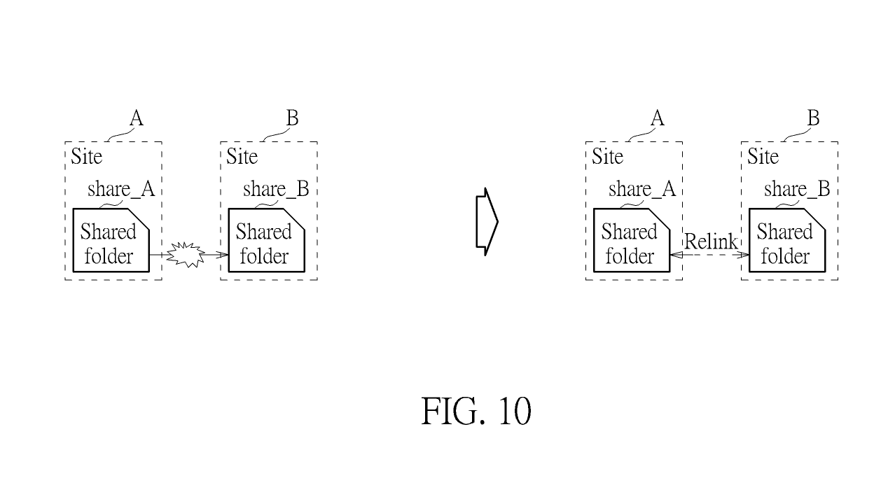

FIG. 10 illustrates one or more broken relationships that can be relinked through the method 300 shown in FIG. 3 according to an embodiment of the present invention, in which the one or more broken relationships may be expressed with the explosion notation between the shared folders share_A and share_B shown in the left-hand side of FIG. 10, and may be taken as an example of the aforementioned at least one replication relationship. For example, one of the two or more storage servers (e.g. one of the sites A and B, such as the site A) may be implemented with the storage server 110 and another of the two or more storage servers (e.g. another of the sites A and B, such as the site B) may be implemented with the storage server 120, but the present invention is not limited thereto. No matter what happens in the break-relationship event, the present invention method (e.g. the method 300) and the associated apparatus (e.g. the storage system 100, the storage server 110, the processing circuit 111, etc.) can relink the one or more broken relationships to prevent unnecessary data transmission for replication, such as a full synchronization operation of transmitting all of the file content data of the file(s) in/of the protection target (e.g. the shared folder share_A) from the storage server 110 to the storage server 120. For brevity, similar descriptions for this embodiment are not repeated in detail here.

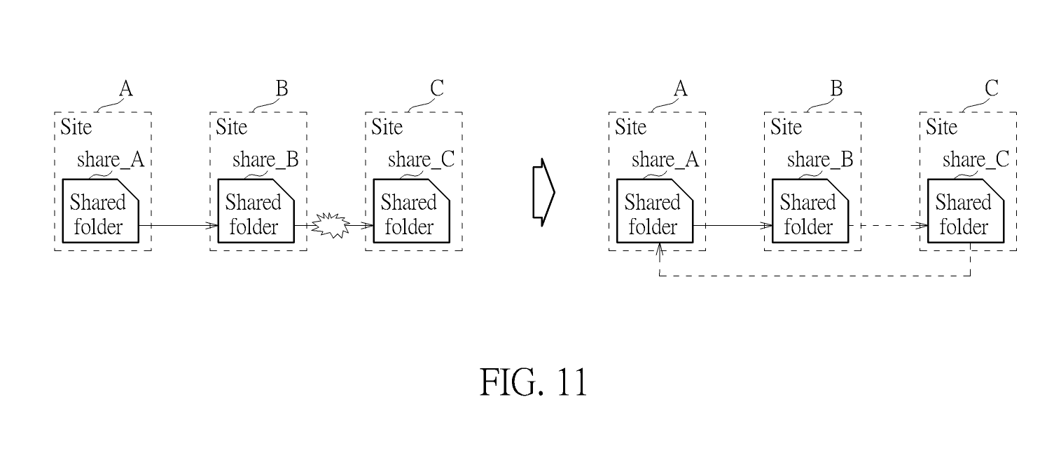

FIG. 11 illustrates one or more broken relationships that can be relinked through the method 300 shown in FIG. 3 according to another embodiment of the present invention, in which the one or more broken relationships may be expressed with the explosion notation between the shared folders share_B and share_C shown in the left-hand side of FIG. 11, and may be taken as an example of the aforementioned at least one replication relationship. For example, one of the two or more storage servers (e.g. one of the sites A, B, and C, such as the site B) may be implemented with the storage server 110 and another of the two or more storage servers (e.g. another of the sites A, B, and C, such as the site C) may be implemented with the storage server 120, but the present invention is not limited thereto. No matter what happens in the break-relationship event, the present invention method (e.g. the method 300) and the associated apparatus (e.g. the storage system 100, the storage server 110, the processing circuit 111, etc.) can relink the one or more broken relationships to prevent unnecessary data transmission for replication, such as a full synchronization operation of transmitting all of the file content data of the file (s) in/of the protection target (e.g. the shared folder share_B) from the storage server 110 to the storage server 120. For brevity, similar descriptions for this embodiment are not repeated in detail here.

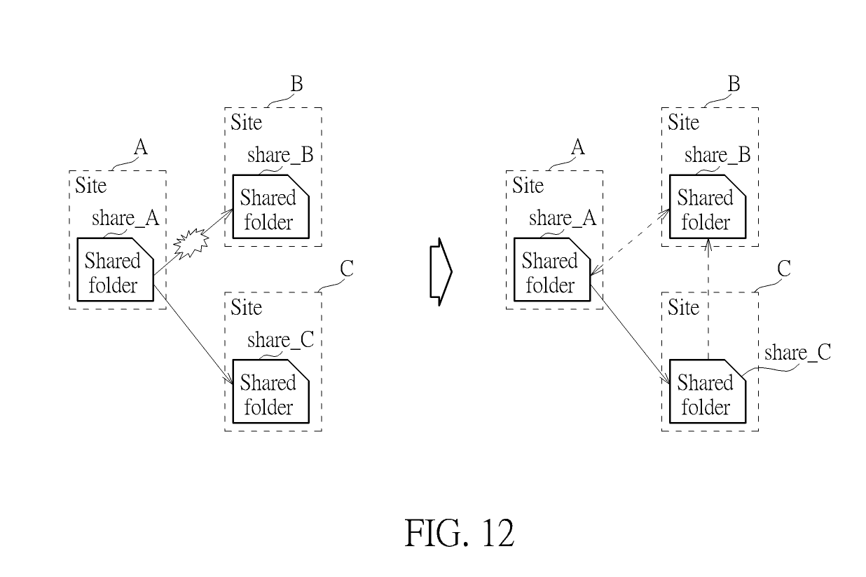

FIG. 12 illustrates one or more broken relationships that can be relinked through the method 300 shown in FIG. 3 according to yet another embodiment of the present invention, in which the one or more broken relationships may be expressed with the explosion notation between the shared folders share_A and share_B shown in the left-hand side of FIG. 12, and may be taken as an example of the aforementioned at least one replication relationship. For example, one of the two or more storage servers (e.g. one of the sites A, B, and C, such as the site A) may be implemented with the storage server 110 and another of the two or more storage servers (e.g. another of the sites A, B, and C, such as the site B) may be implemented with the storage server 120, but the present invention is not limited thereto. No matter what happens in the break-relationship event, the present invention method (e.g. the method 300) and the associated apparatus (e.g. the storage system 100, the storage server 110, the processing circuit 111, etc.) can relink the one or more broken relationships to prevent unnecessary data transmission for replication, such as a full synchronization operation of transmitting all of the file content data of the file (s) in/of the protection target (e.g. the shared folder share_A) from the storage server 110 to the storage server 120. For brevity, similar descriptions for this embodiment are not repeated in detail here.

According to some embodiments, for any snapshot of the plurality of snapshots, the characteristic information of this snapshot may include time information of this snapshot(e.g. the time of generating this snapshot), but the present invention is not limited thereto. For example, the time information may be positioned outside the UID of this snapshot and may be recorded as a portion of this snapshot by the processing circuit 111. In another example, the time information may be positioned within the UID of this snapshot and may be implemented as a portion of this UID. For brevity, similar descriptions for these embodiments are not repeated in detail here.

According to some embodiments, at least one (e.g. one or both) of the roles that the storage servers 110 and 120 play in the storage system 100 may vary. For example, the roles that the storage servers 110 and 120 play in the storage system 100 may be exchanged. As a result, the storage servers 120 and 110 may be taken as examples of the source storage server and the destination storage server, respectively. In this situation, the apparatus may still include at least one portion (e.g. a portion or all) of the aforementioned storage system such as the storage system 100. For example, the apparatus may include a portion of the storage server 120, and more particularly, may include the processing circuit 121. In another example, the apparatus may include the whole of the storage server 120. In another example, the apparatus may include the whole of the storage system 100. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing replication control in a storage system, the storage system comprising a source storage server and a destination storage server, the method comprising:
generating a snapshot of a protection target in the source storage server and characteristic information of the snapshot, and storing the snapshot together with the characteristic information of the snapshot in the source storage server, wherein the snapshot is one of a plurality of snapshots of the protection target that are stored in the source storage server;
transmitting replication data of the snapshot from the source storage server to the destination storage server, to generate a replication version of the snapshot in the destination storage server, wherein the replication version of the snapshot comprises the characteristic information of the snapshot; and
searching for at least one common snapshot between the source storage server and the destination storage server at least according to both of the characteristic information of the snapshot in the source storage server and the characteristic information within the replication version in the destination storage server, and utilizing a latest common snapshot within the at least one common snapshot as reference of replication difference calculation for further replication within the storage system, wherein the snapshot is determined as the latest common snapshot.

2. The method of claim 1, wherein the characteristic information of the snapshot is different from that of any other one of the plurality of snapshots.

3. The method of claim 2, wherein the characteristic information of the snapshot comprises a unique identifier (UID) of the snapshot.

4. The method of claim 3, wherein the UID comprises one or a combination of a serial number, a random number, a code, and a text string.

5. The method of claim 2, wherein the characteristic information of the snapshot and that of the any other one of the plurality of snapshots are utilized for indicating order of generating the plurality of snapshots in the source storage server.

6. The method of claim 1, further comprising:
generating a previous snapshot of the protection target and characteristic information of the previous snapshot, and storing the previous snapshot together with the characteristic information of the previous snapshot in the source storage server, wherein the previous snapshot is within the plurality of snapshots, and the characteristic information of the previous snapshot and the characteristic information of the snapshot indicate that time of generating the previous snapshot is prior to time of generating the snapshot; and
determining order of generating the plurality of snapshots in the source storage server at least according to both of the characteristic information of the previous snapshot and the characteristic information of the snapshot.

7. The method of claim 6, wherein the at least one common snapshot comprises multiple common snapshots between the source storage server and the destination storage server; the common snapshots comprise the snapshot and the previous snapshot; and the method further comprises:
selecting the snapshot as the latest common snapshot according to the order that is determined at least according to both of the characteristic information of the previous snapshot and the characteristic information of the snapshot.

8. The method of claim 1, wherein the at least one common snapshot comprises multiple common snapshots between the source storage server and the destination storage server; the snapshot is one of the common snapshots; and the method further comprises:
selecting the snapshot as the latest common snapshot according to the characteristic information of the snapshot and that of any other one of the common snapshots.

9. The method of claim 1, wherein the step of storing the snapshot together with the characteristic information of the snapshot in the source storage server further comprises:
integrating the characteristic information of the snapshot into the snapshot to store the characteristic information of the snapshot as a portion of the snapshot, to make the replication version of the snapshot in the destination storage server be searchable in a searching operation regarding the at least one common snapshot.

10. The method of claim 9, wherein the replication data transmitted from the source storage server to the destination storage server comprises the characteristic information of the snapshot.

11. The method of claim 1, wherein searching for the at least one common snapshot is performed after replication relationship information indicating at least one replication relationship related to at least one of the snapshot and the replication version of the snapshot is missing.

12. The method of claim 11, wherein the replication relationship information is stored in a system configuration file in a file system of at least one of the source storage server and the destination storage server; and searching for the at least one common snapshot is performed after the system configuration file is damaged or missing or becomes invalid.

13. The method of claim 11, wherein the replication relationship information is a portion of system information of a file system of at least one of the source storage server and the destination storage server.

14. The method of claim 11, wherein the at least one replication relationship comprises a relationship between the snapshot and another snapshot within the plurality of snapshots.

15. The method of claim 14, wherein the replication relationship information is a portion of system information of a file system of the source storage server.

16. The method of claim 11, wherein the at least one replication relationship comprises a relationship between the snapshot and the replication version of the snapshot.

17. The method of claim 16, wherein the replication relationship information is a portion of system information of a file system of at least one of the source storage server and the destination storage server.

18. The method of claim 11, wherein the replication version of the snapshot is one of a plurality of replication versions in the destination storage server; and the at least one replication relationship comprises a relationship between the replication version of the snapshot and another replication version within the plurality of replication versions.

19. The method of claim 18, wherein the replication relationship information is a portion of system information of a file system of the destination storage server.

20. An apparatus for performing replication control in a storage system, the storage system comprising a source storage server and a destination storage server, the apparatus comprising:
a processing circuit, positioned in the source storage server, arranged to control operations of the source storage server, wherein controlling the operations of the source storage server comprises:
generating a snapshot of a protection target in the source storage server and characteristic information of the snapshot, and storing the snapshot together with the characteristic information of the snapshot in the source storage server, wherein the snapshot is one of a plurality of snapshots of the protection target that are stored in the source storage server;
transmitting replication data of the snapshot from the source storage server to the destination storage server, to generate a replication version of the snapshot in the destination storage server, wherein the replication version of the snapshot comprises the characteristic information of the snapshot; and
searching for at least one common snapshot between the source storage server and the destination storage server at least according to both of the characteristic information of the snapshot in the source storage server and the characteristic information within the replication version in the destination storage server, and utilizing a latest common snapshot within the at least one common snapshot as reference of replication difference calculation for further replication within the storage system, wherein the snapshot is determined as the latest common snapshot.
